(19) United States
(12) Patent Application Publication
(10) Pub. No.: US 2026/0369601 A1
(43) Pub. Date: Nov. 19, 2026

(54) NEGATIVE ELECTRODE

(71) Applicant: TOYOTA JIDOSHA KABUSHIKI KAISHA, Toyota-shi (JP)

(72) Inventor: Junta TAKASU, Nayoya-shi (JP)

(73) Assignee: TOYOTA JIDOSHA KABUSHIKI KAISHA, Toyota-shi (JP)

(21) Appl. No.: 19/533,654

(22) Filed: Feb. 9, 2026

(30) Foreign Application Priority Data
May 16, 2025 (JP) 2025-082297

(51) Int. Cl. H01M 4/587; H01M 4/36

(52) U.S. Cl. CPC H01M 4/587; H01M 4/366

(57) ABSTRACT

A negative electrode includes: a negative electrode current collector; a first negative electrode active material layer; and a second negative electrode active material layer in this order, in which: the first negative electrode active material layer includes first graphite and further includes or does not include a first Si-C composite material; the second negative electrode active material layer includes second graphite and a second Si-C composite material; the first graphite and the second graphite include natural graphite; a mass fraction of the second Si-C composite material in the second negative electrode active material layer is higher than a mass fraction of the first Si-C composite material in the first negative electrode active material layer; and a mass fraction of the natural graphite with respect to the second graphite in the second negative electrode active material layer is more than 50%.

### CROSS-REFERENCE TO RELATED APPLICATION

This application claims priority to Japanese Patent Application No. 2025-082297 filed on May 16, 2025. The disclosure of the above-identified application, including the specification, drawings, and claims, is incorporated by reference herein in its entirety.

### BACKGROUND

### 1. Technical Field

The present disclosure relates to a negative electrode.

### 2. Description of Related Art

Japanese Unexamined Patent Application Publication (Translation of PCT Application) No. 2023-546420 (JP 2023-546420 A) discloses a negative electrode including a lower layer portion facing a surface of a negative electrode current collector as a negative electrode active material layer, and an upper layer portion disposed above the lower layer portion. The lower layer portion of the negative electrode includes natural graphite and artificial graphite, and the upper layer portion of the negative electrode includes artificial graphite and silicon oxide.

### SUMMARY

A Si-based active material is being studied. The Si-based active material has a larger specific capacity than a carbon-based active material (artificial graphite, natural graphite). On the other hand, the Si-based active material tends to significantly swell during charging. In order to increase the capacity while reducing swelling, the use of a mixture of a Si-based active material and a carbon-based active material is considered.

In JP 2023-546420 A, a configuration is being studied in which two electrode active material layers are provided, and natural graphite and artificial graphite are included in the lower layer, and artificial graphite and silicon oxide are included in the upper layer. However, there is still room for improvement in reducing swelling.

An object of the present disclosure is to reduce swelling.

Hereinafter, technical configurations and effects of the present disclosure will be described. However, the mechanism of action includes assumptions. The mechanism of action does not limit the technical scope of the present disclosure.

[1] A negative electrode including:
a negative electrode current collector;
a first negative electrode active material layer; and
a second negative electrode active material layer, in an order of the negative electrode current collector, the first negative electrode active material layer, and the second negative electrode active material layer, in which:
the first negative electrode active material layer includes first graphite and further includes or does not include a first Si-C composite material;
the second negative electrode active material layer includes second graphite and a second Si-C composite material;
the first graphite and the second graphite include natural graphite;
a mass fraction of the second Si-C composite material in the second negative electrode active material layer is higher than a mass fraction of the first Si-C composite material in the first negative electrode active material layer; and
a mass fraction of the natural graphite with respect to the second graphite in the second negative electrode active material layer is more than 50%.

In the present embodiment, the Si-C composite material indicates composite particles including at least one of Si and SiO, and carbon. In the Si-C composite material, for example, Si may be supported on a carbon material. The "Si-C composite material" is a general term for a first Si-C composite material and a second Si-C composite material.

Si is a Si-based active material. Si has a large specific capacity, but exhibits significant swelling during charging. Therefore, a Si-C composite material is being studied as a Si-based active material having a smaller specific capacity than Si but exhibiting reduced swelling during charging. However, since the Si-C composite material swells as compared with the carbon-based active material, a measure is required.

According to new findings of the present disclosure, in natural graphite and artificial graphite that are the carbon-based active materials, natural graphite is expected to reduce swelling as compared with artificial graphite. FIG. 1 is a conceptual view of a cross- section of a negative electrode including artificial graphite and a Si-C composite material. FIG. 2 is a conceptual view of a cross-section of a negative electrode including natural graphite and a Si-C composite material. FIGS. 1 and 2 show a state in which a state of charge (SOC) is 100%, that is, a fully charged state in a non-aqueous electrolyte secondary battery including a negative electrode. In FIG. 1, a Si-C composite material 1 swells, and end portions of the Si-C composite material 1 push up an artificial graphite 2 (A region and B region). On the other hand, in FIG. 2, although the Si-C composite material 1 swells, the natural graphite absorbs the swelling and deforms (C region, D region, and E region). That is, the natural graphite is considered to function as a cushion material. As described above, by including the natural graphite in addition to the Si-C composite material as the negative electrode active material, a reduction in swelling is expected.

FIG. 3 is a graph showing a swelling rate with respect to a mass fraction of the natural graphite in a negative electrode including the Si-C composite material and at least one of the artificial graphite and the natural graphite. FIG. 3 shows a state in which the SOC is 100% in the non-aqueous electrolyte secondary battery including the negative electrode. In addition, the horizontal axis shows a mass fraction of the natural graphite with respect to the total mass fraction of the artificial graphite and the natural graphite. It is noted that the negative electrode active material included in the negative electrode includes the Si-C composite material and at least one of the artificial graphite and the natural graphite. As shown in FIG. 3, the swelling rate decreases as the mass fraction of the natural graphite increases. In addition, when the mass fraction of the natural graphite is more than 50%, a greater reduction effect is observed, and when the mass fraction of the natural graphite is 80% and 100%, a more remarkable effect is observed.

[2] The negative electrode according to [1], in which the first graphite and the second graphite include artificial graphite.

The artificial graphite tends to exhibit excellent cycle characteristics (durability) as compared with the natural graphite. In addition, since the natural graphite and the artificial graphite have a difference in hardness and lubricating properties, a moderate unevenness may occur during pressing. The moderate unevenness generates an anchoring effect, and the adhesion between the separator and the negative electrode can be improved. As described above, by including the natural graphite and the artificial graphite in the negative electrode, an improvement in durability is expected.

[3] The negative electrode according to [1] or [2], in which a mass fraction of the natural graphite in the second negative electrode active material layer is higher than a mass fraction of the natural graphite in the first negative electrode active material layer.

By including a large amount of the natural graphite in the second negative electrode active material layer including a large amount of the Si-C composite material, a further reduction in swelling is expected.

[4] The negative electrode according to [1] or [2], in which the mass fraction of the second Si-C composite material in the second negative electrode active material layer is 20% or more.

Even when the mass fraction of the second Si-C composite material in the second negative electrode active material layer is 20% or more, a reduction in swelling by the natural graphite is expected.

Hereinafter, an embodiment of the present disclosure (hereinbelow, can also be simply described as "the present embodiment") will be described. Here, the present embodiment does not limit the technical scope of the present disclosure. The present embodiment is an example in all respects. The present embodiment is not restrictive. The technical scope of the present disclosure includes all changes within the meaning and the scope that are equivalent to the description of the claims. For example, extracting arbitrary configurations from the present embodiment and arbitrarily combining the configurations are contemplated from the beginning.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual view showing an example of a cross-section of a negative electrode including artificial graphite and a Si-C composite material;

FIG. 2 is a conceptual view showing an example of a cross-section of a negative electrode including natural graphite and a Si-C composite material;

FIG. 3 is a graph showing a swelling rate with respect to a mass fraction of the natural graphite in a negative electrode including the Si-C composite material and at least one of the artificial graphite and the natural graphite;

FIG. 4 is a conceptual diagram showing an example of a negative electrode in the present embodiment;

FIG. 5 is a conceptual diagram showing an example of a non-aqueous electrolyte secondary battery in the present embodiment;

FIG. 6 is a conceptual view showing an example of a surface of the natural graphite;

FIG. 7 is a conceptual view showing an example of a cross-section of the natural graphite; and

FIG. 8 is a graph showing a result of an indentation test in the natural graphite and the artificial graphite.

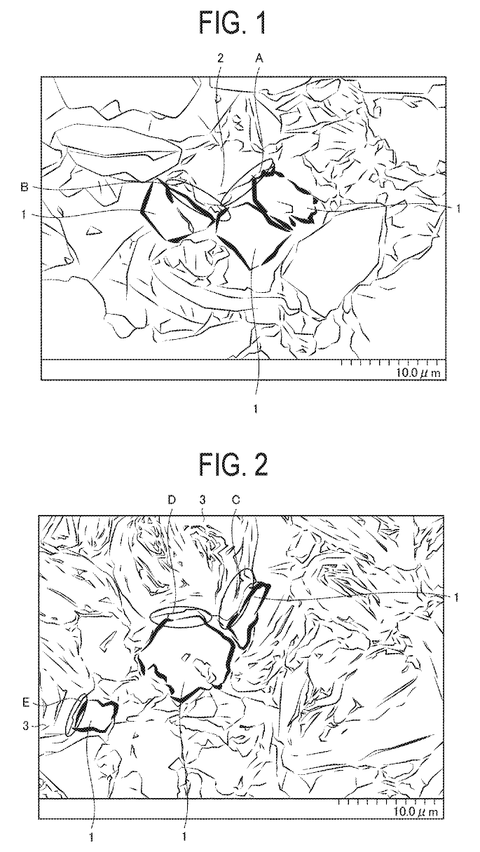

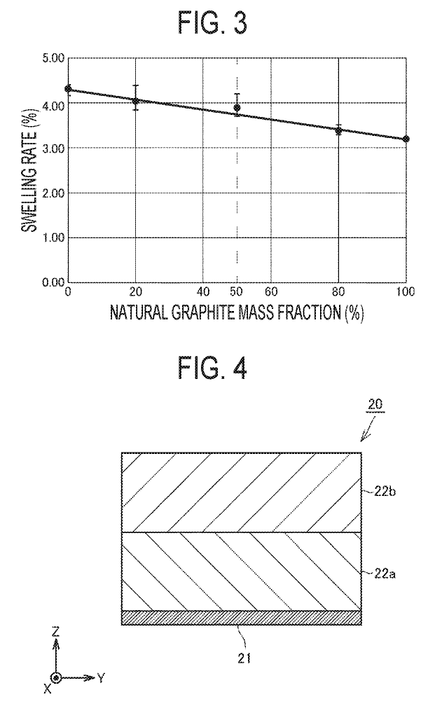

### DETAILED DESCRIPTION OF EMBODIMENTS

### Terms and Phrases

The terms "comprise", "include", "have", and variations thereof are open-ended expressions. A structure expressed in an open-ended manner may further include or may not include additional elements in addition to essential elements. The description of "consisting of" is a closed expression. However, even in the structure expressed in a closed manner, additional elements that are usually accompanying impurities or irrelevant to the target technique may be included. The description of "substantially consisting of" is a semi-closed expression. In the structure expressed in a semi-closed manner, the addition of elements that substantially do not affect the basic and novel characteristics of the target technique is acceptable.

Geometric terms should not be interpreted in a strict sense. Examples of the geometric terms include "parallel", "perpendicular", and "orthogonal". For example, a direction, an angle, a distance, and the like may be relatively displaced within a range in which substantially the same or similar functions are obtained. The geometric terms can include, for example, a design, work, or manufacturing tolerance or error. The dimensional relationships in each drawing sometimes do not agree with the actual dimensional relationships. In order to help the understanding of the reader, sometimes the dimensional relationships in each drawing are changed. For example, a length, a width, a thickness, and the like may be changed. Some configurations may be omitted.

Unless otherwise specified, the singular form is not limited to one element. The singular form also includes a plurality of elements.

The "particle diameter" is specified by microscopy. The particle diameter indicates an arithmetic average of a long side and a short side in a minimum bounding rectangle (MBR) of a two-dimensional image of the particle. The "average particle diameter" indicates an arithmetic average of particle diameters of 100 particles randomly extracted. It should be noted that various image analyses in the present embodiment may be performed by software. For example, "ImageJ" or the like may be used.

The "artificial graphite" refers to graphite synthesized by artificial heat treatment. The artificial graphite is also referred to as synthetic graphite (SD). The "natural graphite" refers to graphite generated in nature. The natural graphite includes flake graphite. The flake graphite may be rounded such that the edges of the particles are bent.

The Si-based active material includes Si (or a Si compound, a Si alloy, or the like) that can be alloyed with Li. The Si-based active material other than the Si-C composite material may include, for example, at least one selected from the group consisting of Si (pure Si), a Si-based alloy, and SiO. SiO indicates composite particles represented by a general formula "SiOₓ (0 < x < 2)".

The "negative electrode active material layer" is a general term for the first negative electrode active material layer and the second negative electrode active material layer.

The negative electrode in the present embodiment can be suitably used in a non-aqueous electrolyte secondary battery such as a lithium ion secondary battery. Hereinafter, the negative electrode in the present embodiment will be described as being used in a non-aqueous electrolyte secondary battery.

### Non-Aqueous Electrolyte Secondary Battery

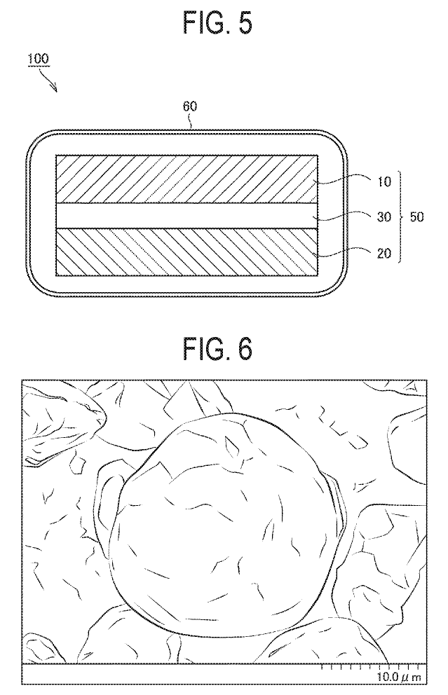

FIG. 5 is a conceptual diagram showing an example of a non-aqueous electrolyte secondary battery in the present embodiment. The non-aqueous electrolyte secondary battery 100 may include, for example, a power generation element 50 and a case 60. The case 60 accommodates the power generation element 50. The case 60 may be, for example, a metal container, an aluminum laminated film pouch, or the like. The power generation element 50 may include, for example, a positive electrode 10, a negative electrode 20, a separator 30, a non-aqueous electrolyte (not shown), and the like. The power generation element 50 may be, for example, a wound type or a laminated type. The power generation element 50 may have a monopolar structure or a bipolar structure. The separator 30 can electrically separate the negative electrode 20 from the positive electrode 10. The separator 30 may include, for example, a porous film made of a resin. The non-aqueous electrolyte is a Li ion conductor. The non-aqueous electrolyte may include, for example, a Li salt and an organic solvent. The non-aqueous electrolyte may be, for example, impregnated into the separator 30. The non-aqueous electrolyte may include, for example, a polymer electrolyte, a gel electrolyte, or a solid electrolyte. The solid electrolyte may include, for example, a sulfide solid electrolyte, an oxide solid electrolyte, a halide solid electrolyte, or the like. The positive electrode 10 includes a positive electrode active material. The positive electrode active material may include, for example, a lithium transition metal composite oxide (Li[NiCoMn]O₂), a lithium phosphate compound (Li[FeMn]PO₄), or the like. It should be noted that the description of [NiCoMn], [FeMn], and the like indicates that the total composition ratio of the components within the brackets [] is "1". The composition ratio of each component is optional as long as the total is 1. For example, the composition ratio of some components may be zero.

### Negative Electrode

FIG. 4 is a conceptual diagram showing an example of a negative electrode in the present embodiment. The negative electrode 20 may be, for example, in the form of a sheet. The negative electrode 20 has a multi-layer structure. The negative electrode 20 includes a negative electrode current collector 21, a first negative electrode active material layer 22a, and a second negative electrode active material layer 22b in this order in a thickness direction. The negative electrode active material layer may be disposed on a part of a surface of the negative electrode current collector 21 or may be disposed on the entire surface. The negative electrode active material layer may be disposed on only one surface of the negative electrode current collector 21 or may be disposed on both surfaces of the negative electrode current collector 21. The negative electrode current collector 21 may include, for example, a metal foil (a Cu foil, a Ni foil, or the like), a conductive resin layer, or the like. The negative electrode current collector 21 may have a thickness of, for example, 1 μm to 100 μm.

The negative electrode 20 may further include any element as long as the negative electrode current collector 21, the first negative electrode active material layer 22a, and the second negative electrode active material layer 22b are included in this order. For example, the negative electrode 20 may include the negative electrode current collector 21, the first negative electrode active material layer 22a, a binder layer (not shown), and the second negative electrode active material layer 22b in this order. For example, a conductive layer, an adhesion layer (both not shown), or the like may be disposed between the first negative electrode active material layer 22a and the negative electrode current collector 21. For example, the negative electrode 20 may include a third negative electrode active material layer (not shown) between the first negative electrode active material layer 22a and the second negative electrode active material layer 22b.

Each layer included in the negative electrode 20 may be, for example, a coating layer. The coating layer indicates a layer produced by applying a coating material. Each coating material may be applied at substantially the same time or may be applied sequentially.

Each layer may independently have any thickness. The thicknesses of the layers may be substantially the same or different from each other.

Each layer may independently have any basis weight. The basis weights of the layers may be substantially the same or different from each other. It should be noted that the "basis weight" indicates a mass per unit area.

Each layer may independently have any porosity. The porosities of the layers may be substantially the same or different from each other. It should be noted that the "porosity" is specified by an image analysis method. The pores and the solids are distinguished by binarizing the cross-sectional SEM images of each layer. The porosity is obtained by dividing the total area of pores (total number of pixels) by the area of the entire layer.

The second negative electrode active material layer 22b is an upper layer. The second negative electrode active material layer 22b may be directly provided on a surface of the first negative electrode active material layer 22a. The second negative electrode active material layer 22b may directly contact the separator 30 in the non-aqueous electrolyte secondary battery 100. The second negative electrode active material layer 22b constitutes the outermost surface of the negative electrode 20. The second negative electrode active material layer 22b includes a negative electrode active material. The second negative electrode active material layer 22b may further include a conductive material, a binder, and the like. The second negative electrode active material layer 22b may include, for example, by mass fraction, 0% to 10% of a conductive material, 0% to 10% of a binder, with the remainder being a negative electrode active material. The second negative electrode active material layer 22b may include, for example, by mass fraction, 0.5% to 1.5% of a conductive material, 0.5% to 3% of a binder, with the remainder being a negative electrode active material.

The negative electrode active material in the second negative electrode active material layer 22b includes second graphite and a second Si-C composite material. For example, the negative electrode active material in the second negative electrode active material layer 22b may consist of the second graphite and the second Si-C composite material.

For example, the negative electrode active material in the second negative electrode active material layer 22b may further include another negative electrode active material. The other negative electrode active material may include, for example, lithium titanate, a Sn-based alloy, SnO, pure Li, a Li-based alloy, or the like. The negative electrode active material in the second negative electrode active material layer 22b does not include a Si-based active material other than the second Si-C composite material.

The second graphite includes natural graphite. The second graphite may consist of natural graphite. The second graphite may include artificial graphite. The second graphite may consist of natural graphite and artificial graphite.

A mass fraction "M_{2N/2G}" of the natural graphite with respect to the second graphite in the second negative electrode active material layer 22b is more than 50%. The mass fraction "M_{2N/2G}" may be, for example, 60% or more, 70% or more, 80% or more, 90% or more, 95% or more, or 100%. The mass fraction "M_{2N/2G}" may be, for example, 100% or less, 95% or less, 90% or less, 80% or less, 70% or less, or 60% or less. When the mass fraction "M_{2N/2G}" is 80% or more, a further reduction in swelling is expected.

A mass fraction "M_{2G}" of the second graphite in the second negative electrode active material layer 22b may be, for example, 40% or more, 50% or more, 60% or more, 70% or more, 80% or more, 90% or more, 95% or more, 97% or more, or 99% or more. The mass fraction "M_{2G}" may be, for example, 99% or less, 97% or less, 95% or less, 90% or less, 80% or less, 70% or less, 60% or less, 50% or less, or 40% or less.

A mass fraction "M_{2N}" of the natural graphite in the second negative electrode active material layer 22b may be, for example, 20% or more, 30% or more, 40% or more, 50% or more, 60% or more, 70% or more, 80% or more, 90% or more, 95% or more, 97% or more, or 99% or more. The mass fraction "M_{2N}" may be, for example, 99% or less, 97% or less, 95% or less, 90% or less, 80% or less, 70% or less, 60% or less, 50% or less, 40% or less, 30% or less, or 20% or less.

A mass fraction "M_{2S}" of the second Si-C composite material in the second negative electrode active material layer 22b may be, for example, 1% or more, 3% or more, 5% or more, 10% or more, 20% or more, 30% or more, 40% or more, or 50% or more. The mass fraction "M_{2S}" may be, for example, 50% or less, 40% or less, 30% or less, 20% or less, 10% or less, 5% or less, 3% or less, or 1% or less. Even when the mass fraction "M_{2S}" is 20% or more, the reduction in swelling by including the natural graphite in the second graphite is expected.

The second graphite may have any average particle diameter. The average particle diameter may be, for example, 1 μm or more, 5 μm or more, 10 μm or more, or 15 μm or more. The average particle diameter may be, for example, 20 μm or less, 15 μm or less, or 10 μm or less. It should be noted that the same range applies to the first graphite described later.

The second Si-C composite material may have any average particle diameter. The average particle diameter may be, for example, 0.1 μm or more, 1 μm or more, 5 μm or more, or 10 μm or more. The average particle diameter may be, for example, 20 μm or less, 15 μm or less, 10 μm or less, or 5 μm or less. It should be noted that the same range applies to a first Si-C composite material described later.

The first negative electrode active material layer 22a is a lower layer. The first negative electrode active material layer 22a may be directly provided on a surface of the negative electrode current collector 21. The first negative electrode active material layer 22a also includes a negative electrode active material. The first negative electrode active material layer 22a may further include a conductive material, a binder, and the like. The first negative electrode active material layer 22a may include, for example, by mass fraction, 0% to 10% of a conductive material, 0% to 10% of a binder, with the remainder being a negative electrode active material. The first negative electrode active material layer 22a may include, for example, by mass fraction, 0.5% to 1.5% of a conductive material, 0.5% to 3% of a binder, with the remainder being a negative electrode active material.

The negative electrode active material in the first negative electrode active material layer 22a includes first graphite. For example, the negative electrode active material in the first negative electrode active material layer 22a may consist of the first graphite. The negative electrode active material in the first negative electrode active material layer 22a may include the first Si-C composite material. For example, the negative electrode active material in the first negative electrode active material layer 22a may consist of the first graphite and the first Si-C composite material. For example, the negative electrode active material in the first negative electrode active material layer 22a may further include another negative electrode active material (as described above).

The first graphite includes natural graphite. The first graphite may consist of natural graphite. The first graphite may include artificial graphite. The first graphite may consist of natural graphite and artificial graphite.

A mass fraction "M_{1N/1G}" of the natural graphite with respect to the first graphite in the first negative electrode active material layer 22a may be, for example, 50% or more, 60% or more, 70% or more, 80% or more, 90% or more, 95% or more, or 100%. The mass fraction "M_{1N/1G}" may be, for example, 100% or less, 95% or less, 90% or less, 80% or less, 70% or less, 60% or less, or 50% or less.

A mass fraction "M_{1G}" of the first graphite in the first negative electrode active material layer 22a may be, for example, 40% or more, 50% or more, 60% or more, 70% or more, 80% or more, 90% or more, 95% or more, 97% or more, or 99% or more. The mass fraction "M_{1G}" may be, for example, 99% or less, 97% or less, 95% or less, 90% or less, 80% or less, 70% or less, 60% or less, 50% or less, or 40% or less.

A mass fraction "M_{1N}" of the natural graphite in the first negative electrode active material layer 22a may be, for example, 10% or more, 20% or more, 30% or more, 40% or more, 50% or more, 60% or more, 70% or more, 80% or more, 90% or more, or 95% or more. The mass fraction "M_{1N}" may be, for example, 95% or less, 90% or less, 80% or less, 70% or less, 60% or less, 50% or less, 40% or less, 30% or less, 20% or less, or 10% or less.

The mass fraction "M_{2N}" may be higher than the mass fraction "M_{1N}". That is, a relationship of "M_{2N} > M_{1N}" may be satisfied. The ratio "M_{2N}/M_{1N}" may be, for example, 1.5 or more, 2 or more, 3 or more, or 5 or more. The ratio "M_{2N}/M_{1N}" may be, for example, 10 or less, 5 or less, 3 or less, or 2 or less.

The first negative electrode active material layer 22a may include the first Si-C composite material. In this case, a mass fraction "M_{1S}" of the first Si-C composite material in the first negative electrode active material layer 22a may be, for example, 0.5% or more, 1% or more, 3% or more, 5% or more, 10% or more, 20% or more, 30% or more, or 40% or more. The mass fraction "M_{2S}" may be, for example, 40% or less, 30% or less, 20% or less, 10% or less, 5% or less, 3% or less, 1% or less, or 0.5% or less.

The mass fraction "M_{2S}" is higher than the mass fraction "M_{1S}". That is, a relationship of "M_{2S} > M_{1S}" is satisfied. The ratio "M_{2S}/M_{1S}" may be, for example, 1.1 or more, 1.3 or more, 1.5 or more, 2 or more, 3 or more, 5 or more, 10 or more, 20 or more, 30 or more, 40 or more, or 50 or more. The ratio "M_{2S}/M_{1S}" may be, for example, 50 or less, 40 or less, 30 or less, 20 or less, 10 or less, 5 or less, 3 or less, 2 or less, or 1.5 or less.

The binder may include, for example, at least one selected from the group consisting of styrene butadiene rubber (SBR), carboxymethyl cellulose (CMC), polyvinylidene fluoride (PVdF), polytetrafluoroethylene (PTFE), and an acrylic polymer. The mass fraction of the binder may be substantially constant throughout the entire region of the negative electrode active material layer. The mass fraction of the binder may be locally different. For example, the mass fraction of the binder may be different between the layers.

The acrylic polymer may be a homopolymer or a copolymer. At least a part of the constituent units of the acrylic polymer is derived from an acrylic monomer. The acrylic monomer may have, for example, at least one of an acrylic group or a methacrylic group. The acrylic monomer may include, for example, at least one selected from the group consisting of acrylic acid, acrylic acid ester, methacrylic acid, and methacrylic acid ester. The acrylic monomer may include, for example, at least one selected from the group consisting of ethyl acrylate, methyl acrylate, butyl acrylate, 2-ethylhexyl acrylate, isononyl acrylate, hydroxyethyl acrylate, methyl methacrylate, glycidyl methacrylate, acrylamide, and acrylamide. A part of the constituent units of the acrylic polymer may be derived from a monomer other than the acrylic monomer. For example, a part of the constituent units may be derived from styrene.

The conductive material may include, for example, acetylene black, carbon nanotube (CNT), vapor-grown carbon fiber (VGCF), and the like. The mass fraction of the conductive material may be substantially constant throughout the entire region of the active material layer. The mass fraction of the conductive material may be locally different. For example, the mass fraction of the conductive material may be different between the layers. For example, the types of the conductive material may be different between the layers.

Whether the graphite is natural graphite or artificial graphite can be determined by, for example, the following method.

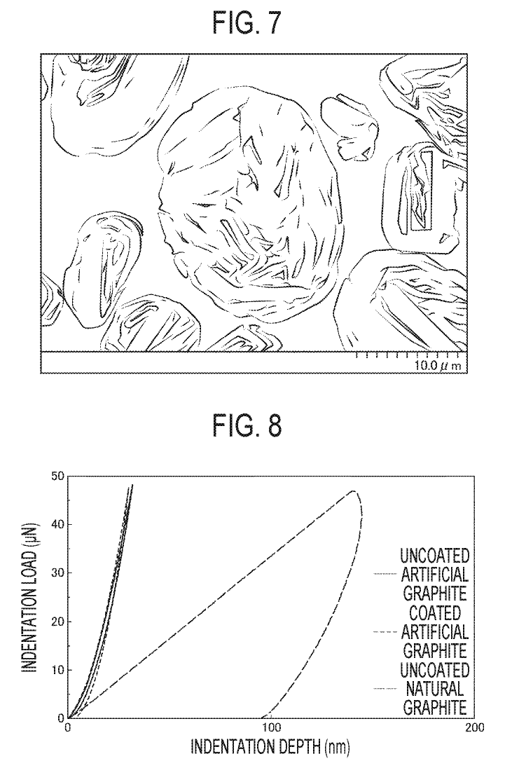

FIG. 6 is a conceptual view showing an example of a surface of the natural graphite. The natural graphite tends to be rounded as compared with the artificial graphite. FIG. 7 is a conceptual view showing an example of a cross-section of the natural graphite. The natural graphite tends to have a hollow layered structure as compared with the artificial graphite.

Based on the above findings, when the graphite has a surface that is rounded and a hollow layered structure in cross section, it is considered that the graphite is likely to be natural graphite.

### Reference Test 1

In order to confirm the degree of deformation of the natural graphite and the artificial graphite, an indentation test was performed. FIG. 8 is a graph showing results of an indentation test for coated artificial graphite, uncoated artificial graphite, and uncoated natural graphite. From FIG. 8, the uncoated natural graphite deformed more easily than the coated artificial graphite and the uncoated artificial graphite. In addition, since the Young’s modulus of the artificial graphite is 5.2 GPa whereas the Young’s modulus of the natural graphite is 1.6 GPa, it can also be understood that the natural graphite deforms easily.

What is claimed is:

1. A negative electrode comprising:
a negative electrode current collector;
a first negative electrode active material layer; and
a second negative electrode active material layer, in an order of the negative electrode current collector, the first negative electrode active material layer, and the second negative electrode active material layer, wherein:
the first negative electrode active material layer includes first graphite and further includes or does not include a first Si-C composite material;
the second negative electrode active material layer includes second graphite and a second Si-C composite material;
the first graphite and the second graphite include natural graphite;
a mass fraction of the second Si-C composite material in the second negative electrode active material layer is higher than a mass fraction of the first Si-C composite material in the first negative electrode active material layer; and
a mass fraction of the natural graphite with respect to the second graphite in the second negative electrode active material layer is more than 50%.

2. The negative electrode according to claim 1, wherein the first graphite and the second graphite include artificial graphite.

3. The negative electrode according to claim 1, wherein a mass fraction of the natural graphite in the second negative electrode active material layer is higher than a mass fraction of the natural graphite in the first negative electrode active material layer.

4. The negative electrode according to claim 1, wherein the mass fraction of the second Si-C composite material in the second negative electrode active material layer is 20% or more.
